(19) United States
(12) Patent Application Publication
(10) Pub. No.: US 2007/0162331 A1
(43) Pub. Date: Jul. 12, 2007

(54) Systems and methods for providing information and conducting business using the internet

(76) Inventor: Michael Sullivan, Herndon, VA (US)

Correspondence Address: LATIMER IP LAW LLP, Suite 122, 13873 Park Center Road, Herndon, VA, 20171, US

(21) Appl. No.: 11/328,457

(22) Filed: Jan. 10, 2006

(51) Int. Cl. G06Q 30/00; G06F 15/173

(52) U.S. Cl. 705/14; 709/238

(57) ABSTRACT

The present invention provides systems and methods of doing business that provide revenue streams to ISP based on advertising revenue for advertisements displayed to ISP customers as a result of Internet communication sessions. In certain configurations, the invention provides redirect services based on pre-defined criteria, and displays advertising on redirection landing pages.

### BACKGROUND OF THE INVENTION

1. Field of the Invention

The present invention relates to computer systems for processing information and providing services using the Internet. It further relates to conducting business transactions using the Internet. More specifically, the invention relates to providing communication services through use of the Internet, providing advertising services through use of the Internet, and to generating revenue through provision of services and advertising over the Internet.

2. Description of Related Art

The Internet has become an integral part of both business and leisure activities. Most businesses now rely on one or more functions of the Internet to conduct normal, day-to-day operations. For example, communication between employees of a business and customers or other employees of the business are now routinely routed via e-mail or other communication systems that use the Internet. In addition, most retailers rely on Internet traffic to advertise their goods and services, whether that traffic is through access to a website owned and operated by the retailer or through advertising purchased by the retailer and presented on landing pages created as a result of a search of the Internet by a user. Furthermore, individual users of the Internet now routinely shop on the Internet, and are increasingly making purchases over the Internet.

Systems and methods for effectively and efficiently providing relevant content, including relevant advertising, to users of the Internet have an advantage over competing systems and methods that are less effective and efficient. For example, search engines that provide highly relevant information in response to search terms are going to be used more often than competing engines that provide only marginally relevant information. Included within the information that could be relevant is advertising content. That is, a user will often value the information provided by advertising if that information is relevant to his query and is presented in a manner that is easy to understand and helpful in making a decision about the original query.

Internet Service Providers (ISP) also require systems and methods for effectively providing information to users. From the standpoint of a subscriber to an ISP, the main function of the ISP is to provide a reliable connection to the Internet so that the subscriber can communicate with others and obtain information from others. An ISP that is more effective and efficient in this regard develops a better reputation among subscribers and accordingly generates a larger subscriber base, which translates into higher revenues for the ISP. On the other hand, a successful ISP also has an opportunity to provide content, such as news, community events, and advertising to a large number of subscribers, making the ISP a valuable outlet for this information.

Although the Internet provides an exceptionally powerful resource for communicating, obtaining information, providing information, and doing business, it has certain drawbacks. For example, communication systems within the Internet can be abused through “spoofing” or “phishing”, activities that route traffic away from the website desired by the user or that trick unsuspecting Internet users into divulging personal information or paying money to individuals who are not the individuals who the Internet users believe them to be. Furthermore, content that some users believe to be inappropriate for others to view (e.g., sites containing pornographic material) can be made available to all Internet users.

There are various systems and methods for providing, controlling, and monitoring Internet communication, some of which also provide systems and methods for conducting business. For example, U.S. patent application publication number 2005/0105513 discloses a system and method for controlling Internet communications such that results from certain queries from Internet users are analyzed for content and either passed through to the users or are intercepted and the users redirected to alternative landing pages that contain relevant content, which can include advertising content. In the system described in that patent publication, the user and/or ISP can identify content that should or should not be presented to the user, and alternative content can be provided in situations where the content returned from the Internet infrastructure has been identified as warranting modification. Where deemed appropriate, the systems and methods can provide advertising content that is relevant to the original query. In doing so, both the Internet user and advertisers reap a benefit, the user by obtaining relevant information and the advertiser by getting his advertising message to a potential customer who is interested in subject matter that is relevant to the advertiser's business.

Although systems and methods for providing Internet communications and for conducting business over the Internet are available, there is a continuing need for systems and methods that provide effective and efficient communication services for ISP subscribers. There is also a continuing need for systems and methods for conducting business over the Internet.

### SUMMARY OF THE INVENTION

The present invention provides computer systems that enable users to communicate over the Internet. It further provides computer systems that provide content-relevant information to Internet users in response to queries for information. In doing so, the systems of the invention provide a method of doing business over the Internet by providing advertising space or content to advertisers in return for monetary payments. Unlike other systems currently in use, the present systems and methods provide a means for revenue generation not only for advertisers and advertising content providers through sale of advertising content, but for an ISP and an individual user as well.

In general, when a user wants to obtain information from a website, he can go directly to the website if he knows the precise Internet Protocol (IP) address or hostname/domain name. In doing so, his web browser submits the address or hostname to the user's ISP servers, which either forward the query directly to the website (if the IP address has been used) such that a direct connection can be made, or (if a hostname has been used) to the Internet infrastructure to resolve the hostname to an IP address, which is then provided to the user's browser such that a direct connection to the website of interest can be made. It is a rare event that a user knows the actual IP address of the website to which he wants to connect. It is furthermore often the case that the user does not know the hostname of the site he wishes to visit; therefore, systems (e.g., search engines) have been developed to provide searching capabilities to convert search terms submitted by users into lists of webpages that might contain relevant content, and preferably contain the website of particular interest to the user. It is also furthermore often the case that the user mis-types the hostname when initiating the search; therefore, systems have been developed to provide search results based on identification of mis-typed queries. Finally, it is often the case that users who realize that they do not know the IP address or hostname of a website containing information of interest to them, and who attempt to find relevant websites through the use of search engines, mis-type one or more words in the query. In these cases, the search engine will either return an error message potentially with a corrected message and a search results page that might or might not contain relevant information. Where a search is performed by a search engine and results are provided to the user, the results often contain advertising content that might or might not be relevant to the subject matter of interest to the user.

Current Internet systems for providing search results for queries from users rely on search engines, such as Google, Yahoo, and Ask Jeeves, to convert queries into relevant content. The search results typically contain advertising content that is paid for by advertisers. There are numerous methods for determining whether a particular advertisement is provided in response to queries, ranging from providing an advertisement for all queries submitted to providing the advertisement only when certain search terms are submitted by the user. Advertisers typically pay the search engine to display the advertisement, based on total number of times the advertisement is displayed, the total number of times users click on the advertisement, or total number of sales generated through the advertisement. Often, search engines pay advertising content providers for advertising content to be posted in response to searches from users of the search engine services. In such a case, revenue is shared among the advertiser, advertising content provider, and search engine. For both the advertiser and search engine, as well as the advertising content providers, providing content-relevant advertising can increase visits to the advertisers' websites by users, and result in higher sales, and thus increased revenue being generated by the advertisers, search engines, and advertising content providers. Systems to improve the relevancy of advertising, including situations where a user has mis-typed a search term or mis-typed hostname/domain name, have been implemented.

The systems in use today provide a means for generation of revenue for advertisers, advertising content providers, and search engines. However, the current systems do not provide a means for revenue generation for ISP or users. The present invention addresses this unmet need by providing systems for doing business over the Internet through the use of computers. The systems are referred to herein as a “shared model” of services. Methods of revenue generation are also provided, which rely on the shared model of services.

In its basic form, the shared model of the present invention provides computer hardware and software to connect Internet users to the Internet, and to provide search results (including advertising content) to those users. Many different computer hardware and software combinations may be used to create the system of the invention. Typically, the system comprises one or more DNS servers that are linked to the Internet infrastructure. A preferred system comprises one or more PLE internet appliances or an equivalent function available from Paxfire, Inc. (paxfire.com; Herndon, Va.).

As discussed above, current Internet search services provide advertising in response to search queries, and generate revenue from that advertising revenue to the advertisers, the search engines, and, if involved, the advertising content providers. Unlike current systems for providing Internet services, the shared model system of the present invention also provides revenue to an ISP from whom the user has contracted services. In embodiments, it provides revenue to one or more companies hosting ISP servers. In embodiments, the system of the invention can also provide revenue to the user who submits a query and ultimately purchases a good or service from an advertiser.

### BRIEF DESCRIPTION OF THE DRAWINGS

The accompanying drawings, which are incorporated in and constitute a part of this specification, illustrate several embodiments of the invention, and together with the written description, serve to explain certain principles of the invention.

FIG. 1 is a diagram of the general architecture and flow of information according to the invention.

FIG. 2 is a diagram of the general architecture and flow of information in an embodiment of a private model system according to the invention, in which an ISP provides the DNS and Internet appliance functions in their “private” network.

FIG. 3 is a diagram of the general architecture and flow of information in an embodiment of a shared model system according to the invention, in which a secondary provider provides DNS and Internet appliance functions for multiple ISPs.

FIG. 4 is a diagram of the general architecture and flow of information in an embodiment of a shared model system according to the invention, in which a network system controller provides reporting, management, and support services to all ISP within the shared model system network.

### DETAILED DESCRIPTION OF VARIOUS EMBODIMENTS OF THE INVENTION

Reference will now be made in detail to various exemplary embodiments of the invention, examples of which are illustrated in the accompanying drawings. The following detailed description is provided to supply a fuller description of certain embodiments of the invention, and is not intended as a limiting disclosure of all embodiments of the invention. Rather, those of skill in the art will be able to understand the full scope of the invention after consideration of the above broad description, the following detailed description of certain embodiments, and the claims.

The present invention provides a shared model for providing Internet communication services to users. In prior patent applications assigned to the assignee of this application (Paxfire, Inc., Herndon, Va.), an Internet appliance having multiple capabilities for controlling and/or monitoring communication traffic to and from the Internet was disclosed. In some instances, the Internet appliance was referred to as a PLE. In essence, among other things, the PLE is capable of analyzing DNS queries sent from users and responses returned from the Internet infrastructure, and redirecting the user to a landing page containing search results, advertising, and/or other information if a pre-defined bit string is encountered. Thus, for example, in response to a mis-typed query, the PLE can redirect the user to a landing page containing links to websites that are potentially relevant to the mis-typed query rather than simply providing an error message and a link to a commercial search engine vendor (e.g., MSN). The present invention builds on the concept embodied by the PLE, and provides new systems and methods for providing Internet searching services, and new systems and methods for generating revenue for ISP, secondary shared services providers (e.g., DNS and PLE hosting sites), and Internet users. While the systems and methods of the present invention are often described with regard to use of the PLE (for the purpose of brevity), they are not limited to use of that Internet appliance. Other appliances or combinations of appliances that achieve the same results or substantially the same results are also envisioned as part of the present invention.

In a first aspect, the systems and methods of the shared model of the present invention provide computer hardware and software to connect Internet users to the Internet, and to provide search results (including advertising content) to those users. The hardware and software can be any that provide the functions described herein. Many different computer hardware and software combinations may be used to create the systems of the invention, and the selection of particular hardware components or software programs is within the skill and abilities of those of skill in the art.

Typically, the system comprises one or more DNS servers that are linked to the Internet infrastructure. Any number of combinations of hardware and software to comprise a DNS server are known in the art, and any such combinations, or any commercially available DNS server hardware and software combination, may be used in accordance with the present invention. One or more of the DNS servers can reside in an ISPs network (or can be under the direct or indirect control of that ISP) from which a user contracts for Internet access service. Alternatively or in addition, one or more of the DNS servers can reside on a secondary service provider that contracts with the ISP to provide DNS services and/or other services. Regardless of whether a particular DNS server is under the control of the ISP or not, each DNS server may be physically located on ISP property or outside of ISP property. In embodiments where multiple ISP are receiving services from the secondary service provider, one or more DNS server may be located and under the control of the secondary service provider. In embodiments relating to the shared services model, typically all of the DNS servers are provided by and under the control of the secondary service provider. Regardless of the physical location or the entity that controls the DNS servers, according to the shared model of the invention, the DNS servers provide the typical functions of a DNS server, as used in other systems known in the art.

In addition to one or more DNS servers, the systems and methods of the invention comprise one or more other hardware and/or software components that, taken as a whole, can analyze Internet traffic and redirect a user to a landing page if one or more pre-defined bit strings are identified. The pre-defined bit string can be anything that a user, the ISP, the secondary service provider, an advertiser, a government, or anyone else with an interest in Internet traffic identifies as containing information that should be blocked, modified, or otherwise treated before or instead of being presented to the Internet (in situations where the bit string is submitted as part of a query by the user) or returned to the user from the Internet infrastructure (in situations where the results return a pre-defined bit string). Thus, for example, the bit string can be an error message generated by the Internet infrastructure to indicate that a requested hostname does not exist. Likewise, the bit string could be a hostname or IP address for a phishing site, a pornographic site, or a website administered by a company that the user has defined as being undesirable. Other non-limiting examples include bit strings submitted in a query by a user that contains a request for pornographic sites, where the bit string is defined by the user or a governmental agency as undesirable.

In a preferred embodiment, the systems and methods comprises one or more PLE Internet appliances available from Paxfire, Inc. (paxfire.com; Herndon, VA) to provide the function of analysis of bit strings and redirection. Various properties and uses of the PLE have been disclosed and discussed in prior patent applications, some of which are currently publicly available. These public documents include U.S. Published Patent Application No. 2005/0027882 and U.S. Published Patent Application No. 2005/0105513. Other U.S. patent documents that discuss some of the properties and uses of the Paxfire PLE include unpublished patent applications Ser. Nos. 11/224,681, 60/683,775, 60/713,753, and 60/717,766. The entire disclosures of all of these are incorporated herein by reference.

Regardless of the precise identity of the hardware and software components that are used to provide analysis and redirection services, these components are provided as part of the systems and methods of the present invention. For ease of future reference, this component of the systems and methods of the invention will be referred to as an “Internet appliance” or a “PLE”. It is to be understood, however, that the invention is not limited to use of the particular hardware and software of the Paxfire PLE or Paxfire Internet appliance provided by Paxfire or disclosed in prior Paxfire patent applications. Rather, use of these terms is for simplicity sake and for ease of reference.

In embodiments, all of the hardware and software for analyzing and redirecting Internet traffic are located within the ISP network, and are physically present within ISP owned or controlled facilities. Thus, in embodiments, all of the DNS servers are owned and operated by the ISP. In embodiments, all of the Internet appliances are owned or leased and operated by the ISP. Thus, in embodiments, all of the DNS servers and Internet appliances are owned or leased and operated by the ISP.

In the various configurations of the system that are possible, one or more of the DNS servers may be owned or leased and/or under the control of the ISP, while one or more other DNS may be owned and/or operated by a secondary service provider. As used herein, a secondary service provider is a company or individual who physically controls one or more DNS, Internet appliance, or both, for the system. The secondary service provider is a distinct legal entity from the ISP. In embodiments, some or all DNS servers are owned, operated, and under the control of the ISP, while all of the Internet appliances are owned, operated, and under the control of the secondary service provider. For example, in a system that is referred to herein as a “private customer” system within the shared services model, an ISP houses, runs, and maintains its own DNS servers, and leases one or more Internet appliances from one or more secondary service providers. The Internet appliances are owned and maintained by the secondary service provider, but are housed and may be operated by the ISP.

In a preferred embodiment of the systems and methods of the invention, which is referred to herein as the “shared customer” services model, all of the DNS servers and Internet appliances are owned, operated, maintained and under the control of the secondary service provider. In essence, in the shared customer model, one or many ISP elect not to maintain their own DNS servers, but instead instruct users (by way of instructions to those users' computers) wishing to access the Internet to look to one or more IP addresses for one or more DNS owned and operated by the secondary service provider. In this way, the secondary service provider acts as a surrogate internet infrastructure service provider for the true ISP, and provides not only typical DNS functions, but bit string analysis functions and redirect functions as well. Depending on the Internet appliance used by the secondary service provider, other services may also be provided by the Internet appliance (e.g., the PLE of Paxfire provides numerous services). In this scenario, the secondary service provider can maintain multiple DNS servers and multiple Internet appliances, along with all other necessary hardware and software for providing Internet access (e.g., firewalls, load balancers, DHCP or RADIUS servers, etc.) to the users. It also may act as a surrogate host for multiple ISPs at the same time, thus “sharing” its services with multiple ISP at the same time. This embodiment is envisioned to be particularly attractive to small ISPs that prefer to avoid the cost of purchasing and maintaining their own DNS servers.

Of course, it is possible for an ISP to maintain its own DNS servers, but funnel all Internet traffic through an Internet appliance operated and maintained off-site by a secondary service provider. In such a situation, the ISP DNS servers would simple direct all traffic through an IP address representing an Internet appliance operated by the secondary service provider. As should be evident from this and other exemplary embodiments, it is not critical where each component of the systems of the invention reside or what entity is tasked with ownership and maintenance of each component.

As a general matter, content provided by the Internet appliance through the action of a results server after analysis of Internet traffic will be provided by the entity in control of the Internet appliance. Thus, if the secondary service provider retains control of the appliance (e.g., through a lease of the appliance to the ISP), then content presented will be controlled by the secondary service provider. Alternatively, if the ISP has control of the appliance, it can dictate, at least to some extent, the content supplied in response to analysis of bit strings supplied by the user or from the Internet. Content will generally be provided by external content providers, such as search engines and advertising content providers. However, it is also possible for the secondary service provider to provide content on its own (either generated in whole or in part by the secondary service provider). It is also possible for the ISP to provide some or all of the content provided in response to queries.

In any given configuration of a system of the invention, one or more DNS servers and one or more Internet appliances may be included. In certain embodiments, the secondary service provider provides combinations of DNS servers and Internet appliances at multiple, geographically separated sites throughout a country (e.g., the U.S.). For example, a shared services system may comprise one or more DNS and Internet appliances at each of one or more locations on the East coast of the U.S., the Midwest of the U.S., and the West coast of the U.S. Thus, for example, a secondary service provider may have, in one shared model system, one or more combinations of DNS server(s) and Internet appliance(s) in or around Washington, D.C., Atlanta, Ga., Chicago, Ill., Dallas, Tex., Denver, Colo., San Diego, Calif., and/or San Jose, Calif. Having multiple geographic locations permits the secondary service provider the ability to maintain multiple hardware/software combinations on different power grids and in different locations having different weather patterns or subject to different natural phenomenon/disasters. It also permits the secondary service provider to use different Internet access providers and infrastructure (e.g., cable or DSL connections provided by different providers) to provide services. In general, having multiple locations permits a higher level of service to be provided because it permits back-up systems to be instituted, such that failure of one particular site can be compensated for by one or more other sites, thus providing uninterrupted service to the ISP participating in the shared services model. This aspect of the system is referred to herein as a co-location aspect.

In embodiments, the invention includes a private customer system of the shared services model, as discussed above. In these embodiments, multiple ISP may utilize the services of the secondary service provider at the same time. Thus, for example, the shared services provider might have a single set of parameters for bit string recognition and redirection (e.g., a list of phishing sites), which is provided individually to all ISP participating in the shared model of the invention, but which results in all ISP redirected users to a common landing page/results server having similar or identical search results. Accordingly, while each particular private customer ISP may have one or more Internet appliances connected to its DNS servers at its particular geographic location, the Internet appliances at all of the ISP might provide similar or identical search analysis and redirection services, thus essentially sharing resources (e.g., ad content) with all other ISP in the system. Of course, each ISP, and even each user within an ISP network, may independently define particular bit strings as relevant for analysis and redirection. Furthermore, each individual user may opt in or opt out of the analysis and redirection services.

Likewise, and as discussed above, in the shared services model of the invention, multiple ISPs will use the DNS and Internet appliances of the secondary service provider. In such a situation, each ISP and even each particular user may define its own set of bit strings for analysis and redirection. Alternatively, each ISP or each particular user may accept a standard set of bit strings that are defined by the secondary service provider as flags for redirection. As with all embodiments of the systems of the invention, each particular ISP and user may opt in or out for various services.

The systems of the invention permit a secondary service provider to provide one or more private customer systems and one or more shared systems within the same overall shared resources system. Thus, a single secondary service provider may, at any one time, provide analysis and redirection services to one or more ISP under a private customer system, while providing analysis and redirection services to one or more ISP under a shared system. Each ISP within the system may use the same or different parameters for analysis of bit strings for redirection. Indeed, each particular user within all of the ISP for which secondary services are provided may define personalized parameters (including opting out of the services) for analysis and redirection. Furthermore, the content of the redirect webpage provided for each user or all users for a particular ISP may be defined by each ISP for its users.

In the systems of the invention, the Internet appliance (regardless of where it sits) acts as a selective filter to identify bit strings of interest (either submitted from the user or returned from the Internet) and cause a redirection of the user to a landing page if it encounters those bit strings. The Internet appliance is also capable of analyzing the bit string and providing relevant content instead of the specific content requested. Although there are many ways in which the Internet appliance may do so, in preferred embodiments, the Internet appliance analyzes the bit string and compares it to tables it contains that match bit strings with pre-defined responses. The Internet appliance, when it is able to make a match, supplies the pre-defined response to the user as or as part of a redirect landing page. For example, where a response to a query returns a phishing site, the Internet appliance can return a landing page that identifies that site as a phishing site, and possibly also blocks the user from visiting the site. Where there is no exact match, the Internet appliance can generate a series of responses based on any number of criteria. For example, where the user has requested a particular website that advertises low interest rate loans, but in fact is a scam, the Internet appliance can identify the site as an undesirable site, and instead provide links to reputable lending institutions by way of advertisements. Other uses for the Internet appliance will be immediately apparent to those of skill in the art from considering this disclosure and those of the U.S. patent documents discussed above.

The systems of the invention will include, in addition to the DNS server(s) and Internet appliance(s), Results Servers, herein referred to generically as “web servers”. The web servers typically will be owned, operated, and maintained by the secondary service provider. The web servers will run standard web server software along with custom application software for the systems of the invention. In addition to typical web server functions, the web servers of the present systems can provide the following functions: accept request from users and turn the requests into a webpage of results that contains relevant content, including advertising and search result information; provide users the option to participate in the analysis and redirection functions of the system; allow users to define search result parameters to limit results obtained from particular searches (e.g., searches for “movies” will not provide results for R-rated or X-rated films); allow users to define search result parameters based on the user (e.g., children in a family performing a search for “movies” will not be provided with results containing movies rated R or X); and interact with advertising content providers as well as search providers to construct a webpage containing search results and advertising.

As a general matter, the systems of the present invention do not alter in any significant way, a user's ability to access the Internet. That is, unless a pre-defined bit string is encountered by the system, any given user will likely not realize that his access to the Internet is being provided under the shared model system of the present invention. Indeed, some users will not realize that certain services are being provided by a secondary service provider at all.

In some embodiments, the secondary service provider will, in addition to running the Internet appliance(s) and, possibly the DNS server(s) for one or more ISP, will also provide and maintain one or more hardware/software combinations that provide background support services for one or more ISP. For example, the secondary service provider may provide a centralized update service for the ISP, in which new information is provided to the Internet appliances of the ISP on a periodic basis. Non-limiting examples of such a service are: to daily update phishing sites, to update pornographic sites, to update sites that surreptitiously install spyware on user's computers, and to provide service packs/patches/fixes for the software implementing the systems. Service functions can also include maintaining an account of costs incurred by the ISP for the services or revenues credited to the ISP. Other financial information can also be supplied, as requested by the ISP. Furthermore, the support services can include reporting functions, which, in addition to reporting financial information, can report to the ISP information regarding the number of users participating in the system, the number of redirections performed in a given time period, the amount of revenue generated, and the like. The reports can be tailored in any number of ways, including, but not limited to, one or more report for each individual user, for each ISP location (where a single ISP has multiple locations or has dedicated certain users to certain Internet appliance locations), for each time period (e.g., time of day, day of month, month per year), and for each particular bit string or class of bit strings.

Support services can be supplied to the ISP via the Internet appliance, by way of updating the appliance manually or automatically. In embodiments, the Internet appliance is updated automatically through Internet connections. In certain embodiments, a hardware/software component is included in the ISP or secondary service provider to accept and process information relating to support. For ease of reference, this hardware/software component is referred to herein as a dynamic controller. In these embodiments, the dynamic controller receives updated information from the secondary service provider by way of the hardware/software providing the support functions, and the dynamic controller updates the Internet appliance or results server with the new information. The dynamic controller may also be in communication with the DHCP or RADIUS servers of the ISP to identify particular users and information relevant to those users (e.g., the opt-in or opt-out status). The dynamic controller may also provide other functions, such as IP address tracking for each particular user within an ISP network. One exemplary function of the dynamic controller is to receive information from the support services hardware/software component of the secondary service provider relating to newly discovered phishing sites, and to pass that information on to the Internet appliance, such that the Internet appliance can update its tables to block users from translating the phishing site domain into an IP address.

In embodiments, the systems of the present invention also provide a means for the secondary service provider to collect and analyze data from the use of the systems. This process is preferably performed “off-line”. That is, to avoid potential problems with delays in the systems or leaks of information, it is preferred that, where a systems analysis component is to be included in the overall system, it is provided as a set of separate hardware/software components that receive information from one or more components of the system, but do not otherwise participate in the system. This function is referred to herein as a co-location function. In general, it can be thought of as a mirroring function that obtains information from the system, but does not directly return any information. The information obtained is used outside of the Internet communicating links of the system, and is used for various purposes, such as to monitor the performance of the systems, to identify and correct bugs in the system, for archiving and back-up purposes, and to preserve financial or other confidential or sensitive information (preferably in secure, encrypted format).

Other components of the systems of the present invention are content providers. In embodiments, the secondary service provider will provide search capabilities and/or advertising content for users. However, in other embodiments, external content providers will be relied upon to provide these services. For example, a common search engine, such as Google, Yahoo, or Ask Jeeves, will be used to provide search results for searches submitted by users. Likewise, for example, advertising content will be provided by advertising content providers, such as Google. In preferred embodiments, the system relies on two or more content providers to provide search results, advertising, or both. In embodiments where multiple content providers are available, the systems of the invention, and in particular the web servers maintained by the secondary service provider, will send requests out to two or more of the content providers, and analyze the results returned from those content providers. A decision will be made as to which results to use, and this decision will be based on any number of criteria, including, but not limited to, speed at which the results were returned, number of results provided, and relevance of results provided. The selected results will then be passed on to the user. This series of events will occur both in situations where a query and result containing no pre-defined bit strings exist and in situations where a query or result contains a pre-defined bit string. That is, when a pre-defined bit string is encountered, a second search can be initiated by the web server, based on pre-defined parameters, to provide acceptable search results and advertising, if possible. Of course, when a search result is acceptable with the exception of one or more results (e.g., when a phishing site is returned among multiple bona fide results), the results can be accepted and returned to the user, with the exception of the modification of the offending results.

Just as the system may include multiple content providers, it also can include multiple advertising content providers, or multiple individual advertisers. Any combination of advertising content providers or individual advertisers can be include within the system, the number and identity being determined for each system or even each search. Numerous advertising content providers are known (Google currently having the largest market share), as are individual advertisers.

In a second aspect, the present invention provides methods of doing business using a computer, particularly over the Internet. The methods provide ways to generate revenue based on processing information present in Internet traffic. In general, the methods of doing business are based, at least in part, on providing advertising in response to queries submitted by Internet users. Revenue that is generated using the business methods of the present invention can be generated for the benefit of one or more ISP, one or more secondary service providers, one or more content providers (e.g., search engines), one or more advertising content providers, one or more advertisers, one or more bank or financial institution, one or more person who uses a computer to search the Internet and/or purchase products or services over the Internet, or a combination of two or more of these.

As discussed above, current Internet search services provide advertising in response to search queries, and generate revenue from that advertising to the advertisers (through purchases of products/services), the search engines (through ad sales), and, if involved, the advertising content providers (through ad sales). Unlike current systems for providing Internet services, the shared model system of the present invention also provides revenue to an ISP from whom the user has contracted services, a secondary service provider who provides DNS and/or redirection services, and, in embodiments, the user who submitted the query. In preferred embodiments, it provides revenue to one or more companies hosting ISP servers, such as secondary service providers. Also in preferred embodiments, the system of the invention also provides revenue to the user who submits a query and ultimately purchases a good or service from an advertiser.

According to the systems and methods of the present invention, analysis of bit strings submitted over the Internet by a user are analyzed and either passed through to the Internet infrastructure or redirected to a landing page. In embodiments, both out-going and in-coming bit strings are analyzed. In other embodiments, only out-going or only in-coming bit strings are analyzed. An Internet appliance performs the decision-making task by comparing the bit strings to a set of pre-defined bit strings. In the case where out-going information is analyzed, if the bit string submitted by the user matches one or more of the pre-defined strings, redirection occurs before the information is submitted to the Internet infrastructure. If not, the bit string (e.g., search query) is passed on to the Internet infrastructure. Typically, in return, the Internet infrastructure provides the user with information. In embodiments where in-coming information is analyzed, prior to reaching the user, the information (bit strings) from the Internet is compared to the pre-defined set of bit strings to determine if redirection is to occur. Where a pre-defined bit string is encountered, redirection to a landing page occurs. If no pre-defined bit string is encountered, the information from the Internet is passed on to the user.

In situations where redirection occurs, for whatever reason and at whatever point in transmission of information from the user to the Internet, the methods and systems of the invention provide an opportunity for revenue to be generated. In the redirection process, the user is directed to a landing page that contains information relevant to the initial query, whether that information be search results, advertising, or an error or warning message, or a combination of two or more of these or other information. In the process of redirecting the user to a landing page, the systems and methods of the invention create the landing page based on the original query, the pre-defined bit strings, advertising content, policies of the ISP, pre-selected parameters defined by the user or the administrator in charge of the user's computer, and various other information. In general, the landing page contains information that is relevant to the original query, such as search results that relate to the query. It also typically will contain advertising content. The advertising content is preferably relevant to the user, such as relevant to the subject matter of the query, relevant to the geographical location of the user, relevant to previous searches performed by the user, or relevant to pre-defined criteria established by the user.

According to the methods and systems of the present invention, advertising content provided on the landing page is ultimately paid for by advertisers. These advertisers may pay any number of entities involved in the systems, but typically pay the company that hosts the ISP services (e.g., the ISP or the secondary service provider) or pay one or more advertising content providers (e.g., Google) to provide their advertisement in response to pre-defined words or phrases. Where the advertiser has paid an advertising content provider, the advertising content provider will provide advertisements for its various customers in response to queries submitted to it by the ISP or the secondary service provider, which are based on the original query submitted by the user. The advertisements, whether provided by the advertiser directly to the ISP or secondary service provider or via an advertising content provider, will be included in the landing page, for viewing by the user.

Typically, when advertising content is provided in systems currently in use (i.e., without implementing the systems and methods of the present invention), revenue is generated through advertising based on users' visitation to search engines, advertisers' websites or, more typically, through purchases made by users through links provided by the advertiser or advertising content providers in response to the users' queries. The revenue is provided as a payment from the advertiser to the advertising content provider as a “reward” for placing the advertising on the search result page. In those systems, revenue is not generated for the ISP or any other entity involved in hosting of the ISP services. Likewise, the end user (i.e., the product or service purchaser) does not receive any financial gain from placement of advertising on the search results page.

In contrast to the systems currently in use, the present invention provides revenue to participants other than the advertiser and advertising content provider. According to the present systems and methods, revenue is generated for the ISP participating in the shared model system. More specifically, most companies that provide DNS hosting services charge ISP for those services. In addition, where redirection services are provided, a charge to the ISP is typically also involved. In the present system, an ISP will be charged for services provided by the secondary service provider, including DNS hosting and redirection services. However, under the present systems and methods, the ISP will be able to recoup some or all, or even excess, revenues paid to the secondary service provider by sharing in revenue generated as a result of visits to advertisers' websites by ISP customers (i.e., users). That is, the secondary service provider will charge advertisers and/or advertising content providers to provide advertisements on the landing pages that are generated through use of the Internet appliance/search results server of the systems and methods of the present invention. This revenue can be shared with the ISP or others (as discussed below). Revenue sharing can be based on any common plans, such as based on number of visits by ISP customers, number of purchases by ISP customer, or amount of money spent by ISP customers. Revenue will be made available by the systems and methods of the invention based, at least in part, in better targeting of advertisements to particular users, based on various parameters that may be available through the use of an Internet appliance and redirection method of the invention. In essence, the present systems and methods can provide better targeting of advertising than other systems and methods in current use, and thus will be able to provide a higher rate of return on advertisers' investments in advertisements to be displayed in response to users' queries. In embodiments, one benefit of the system is that secondary service providers can provide relevant search results to a user who makes a mistake, without the user having to first go to a search page and enter or re-enter the query. Even if the user does not make a mistake, the system enables entering of search terms in the location/address bar because, when that is done, the Internet infrastructure returns an error message, and the present system can analyze what was typed.

The amount of revenue generated by an ISP through the fee sharing systems of the present invention can be small or large. It is envisioned that certain ISP will generate sufficient traffic to advertisers' sites to recoup much, if not all, of the costs charged by the secondary service providers. In essence, in such a situation, the ISP might receive its DNS hosting and redirection services at no charge. This could be a significant advantage for small ISP. In certain situations, the ISP might generate a profit by utilizing the services of the secondary service provider. This is a clear advantage to all ISPs.

Of course, the secondary service provider may elect to retain some revenue from presentation of advertising content on the landing page. Whether to do so, and the amount to be retained may be determined by each secondary service provider based on any number of parameters. In certain situations, the secondary service provider may provide advertising content to the ISP directly, such as by display on the ISP home page. This is an additional source of revenue for the secondary service provider, which may be shared with the ISP.

In some embodiments, the revenue generated by the systems and methods of the present invention are shared with the ISP customers. That is, in some situations, an ISP may elect to share with its customers the revenue it receives as a result of customer use of advertisers' websites. In this situation, the ultimate user (i.e., the ISP customer) will receive revenue based on his searches. There are, of course, any number of schemes for revenue distribution and sharing that can be imagined in such a situation. Examples include, but are not limited to, users receiving a cash payment for a percentage of the cost of purchases made through links to advertisers advertising on the landing pages supplied by the secondary service provider; and users receiving a credit toward their ISP bill for a percentage of the cost of purchases made through links to advertisers advertising on the landing pages supplied by the secondary service provider. In embodiments, ISP customers might receive their ISP service for free, if the amount of their purchases was sufficient. Of course, fee sharing plans with ISP customers will be determined by the ISP, and can include any type of plan, including payment to individuals based on their particular purchasing behavior, or payments to all ISP customers on a pro-rated bases, based on total purchases of all ISP customers. The systems and methods of the present invention provide the ability for an ISP to track individual purchases, so any scheme for revenue sharing may be implemented. Revenue can also be generated from fixed monthly fees or per-transaction fees. For example, every time a user is stopped from going to a phishing site, revenue can be generated.

According to the present invention, advertisers and advertising content providers continue to generate revenue for the services they provide, in accordance with general schemes in place in current systems. The percentage of total revenue each generates based on any particular sale may be altered, or may remain the same. The revenue sharing scheme between advertiser, advertising content provider, and secondary service provider may be adjusted and altered for each particular ISP involved, based on any number of parameters and business requirements. Regardless of the exact plan put in place, it is envisioned that the advertisers will continue to share revenue generated by sales through Internet business with the advertising content providers, and, ultimately, the secondary service provider.

In summary, there are multiple entities that can generate revenue from use of the systems and methods of the present invention. Initially, advertisers generate revenue through sales of services and products to Internet users who find their advertisements on landing pages generated as a result of the present systems and methods. Advertising content providers generate revenue, typically as a percentage of sales generated by advertisers using the content provider's services, as a result of Internet users making purchases from the advertisers. The secondary service providers generate revenue in multiple ways. First, they generate revenue through charging ISP to user their DNS and/or Internet appliance services. Second, they generate revenue through fee sharing with the advertisers or advertising content providers, based on users' viewing or clicking of ads as well as purchases of goods or services from advertisers who have advertisements on the redirect landing pages generated by the secondary service provider's systems. In embodiments, the ISP may also generate revenue from use of the present systems and methods. In those embodiments, the ISP generate revenue through fee sharing with the advertisers, advertising content providers, and/or secondary service providers. Typically, the revenue will be based on users clicking on or viewing ads by ISP customers. In yet further embodiments, the ISP customers may generate revenue through use of the present systems and methods. The customers (users) may obtain cash or monetary credits based on purchase made from advertisers who advertise on landing pages supplied by the secondary service providers, using the present systems and methods.

Other entities that can generate revenue through use of the present systems and methods include search content providers (e.g., search engines), which might provide advertising content as part of a package with search results, or independent of search results. Furthermore, financial institutions, such as banks, may generate revenue as a secondary effect of the methods and systems of the present invention, by way of service fees charged to any one or more of the above-mentioned entities, to transfer money from one account to another, or to maintain an account from which money is to be transferred into and out of.

One further aspect to be mentioned is the increased traffic that can be achieved through use of the present systems and methods. Users who are aware of the systems and methods, and the power that they provide over other systems and methods, will contract for services from ISP who use the present systems and methods. This activity increases the subscribership of the ISP, and generates increased revenue for the ISP. It also provides a feed-back loop that further increases revenue for the ISP, the secondary service provider, and preferably the ISP subscriber, by increasing the amount of purchases made by users of the ISP, and thus increasing the amount of revenue available for sharing.

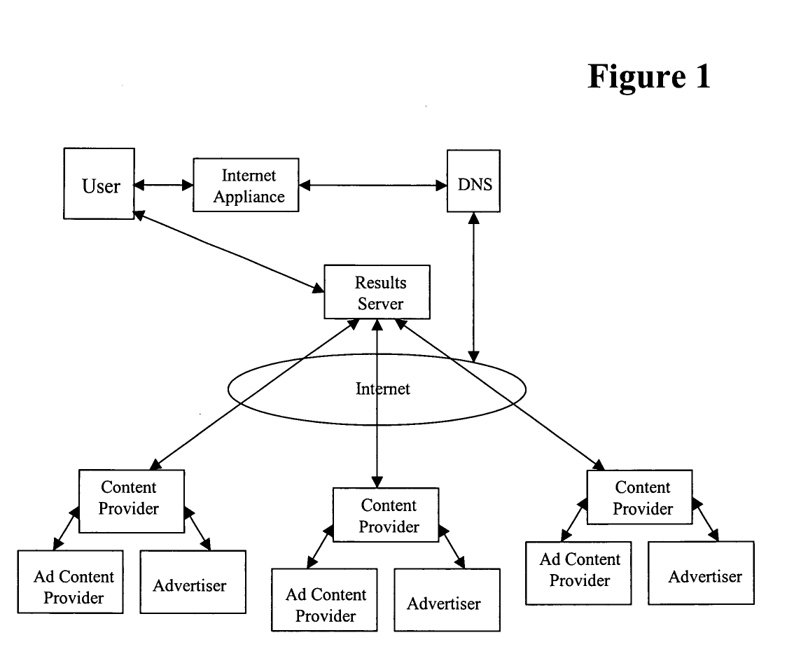

Turning now to the figures, which depict various exemplary embodiments of the invention, FIG. 1 depicts a scheme for an architecture of the shared ISP model according to the invention. In this scheme, a user submits a query to the Internet for certain information. The query is passed thru the Internet appliance and received by a DNS of the invention. The Internet appliance analyzes the query for various information, including pre-defined bit strings, and, if no pre-defined bit strings are encountered, forwards the query on to the Internet infrastructure for resolution. If the query matches any of the pre-defined bit strings or other rules, the Internet appliance will direct the end user's system to the Results Server. The Results server will then submit the query or a modified version of the query to one or more content providers (e.g., Google, Ask Jeeves, Yahoo), and the content providers analyze the request and generate search results. At the same time, the content providers request advertising content from advertisers or advertising content providers, and integrate that advertising into the search results. The search results are returned to the Results server, which selects one search result set (if multiple content providers are used) and analyzes it, and passes the results on to the user.

In the event that a pre-defined bit string is encountered in either the query or the results provided by the content provider selected, the Results server alters the query or results, generates an alternative search and submits that search to one or more content providers for resolution. The content providers provide the search results and advertising content, and the Results server causes a landing page to be generated with the alternative search results selected from among the results provided. Advertising content on the landing page can be subject to the fee sharing model of the invention, in which revenue generated from purchases from advertisers by users is shared among at least two of: the advertiser, the advertising content provider, the search content provider, the Results Server owner, the Internet appliance owner/manager, the DNS owner/manager, and the user.

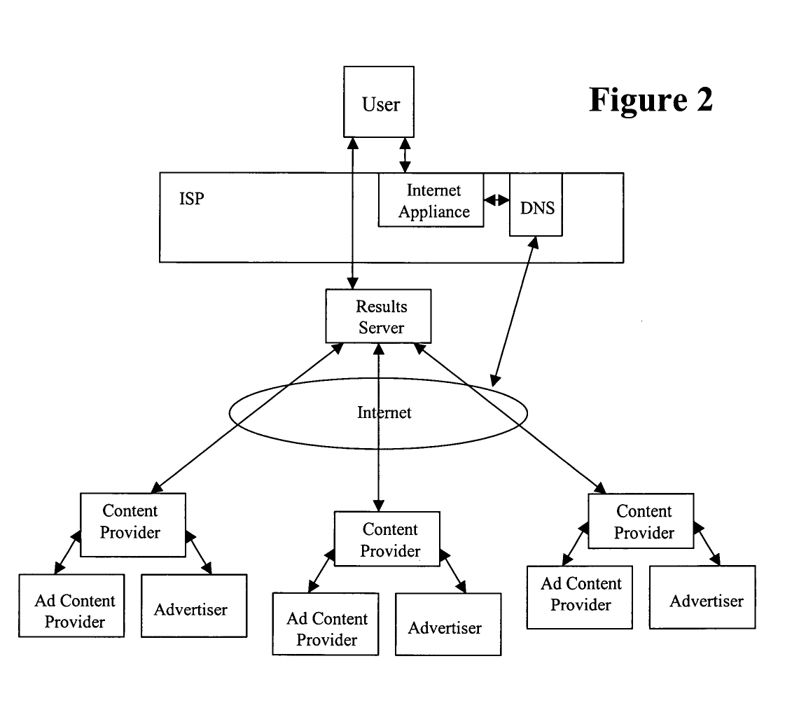

FIG. 2 depicts a general scheme of an embodiment of the invention referred to as a “private customer” shared model. In this embodiment, an ISP owns and operates its own DNS (only one DNS is shown for simplicity, but it is to be understood that multiple DNS may be present in an actual system). It also houses an Internet appliance in its network or “virtual” network, which is typically under the ownership and control of a secondary service provider, but is leased from that provider to the ISP. The transmittal of information through this system is the same as discussed above with regard to FIG. 1. Fee sharing in this embodiment of the model of the invention can include the ISP along with the entities discussed above with regard to FIG. 1.

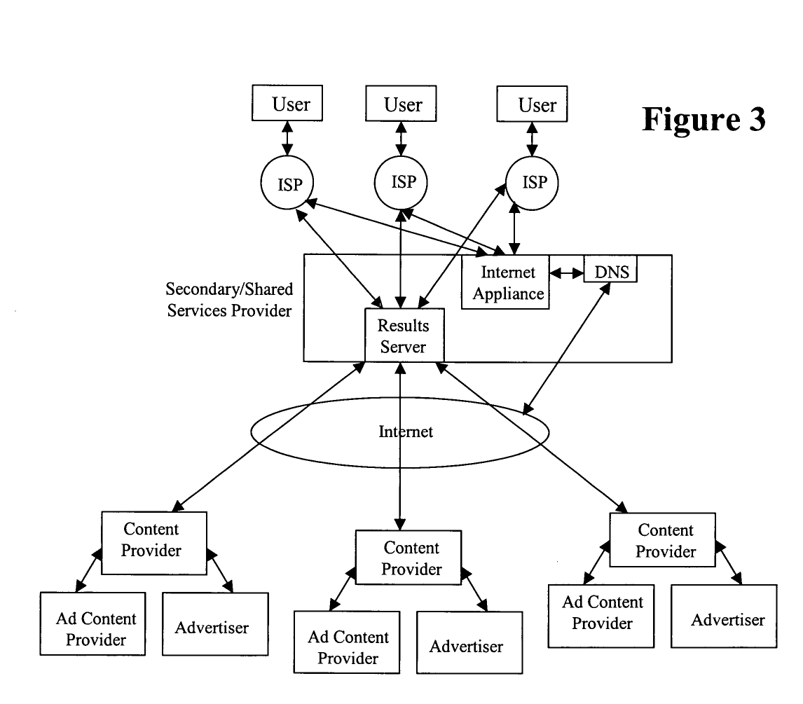

FIG. 3 depicts a general scheme of an embodiment of the invention referred to as a “shared customer” shared model. In this embodiment, a secondary service provider provides DNS and Internet appliance functions for one or more ISP (three ISP are indicated in the figure, any number of ISP may share the resources of the secondary service provider). The DNS and Internet appliance are under the control and ownership of the secondary service provider. In essence, the secondary service provider provides DNS and Internet appliance (including redirection services) to the ISP customers in a seamless fashion in the background. ISP participating in the shared service model point their customers to the DNS owned and operated by the secondary service provider, and in return, the secondary service provider provides the services the ISP needs. According to the revenue distribution model of the invention, the secondary service provider may charge the ISP for the services, or may provide them free of charge. The secondary service provider is able to recoup some revenue by receiving a payment from advertisers, advertising content providers, or content providers for placing advertising on landing pages generated through its services and equipment. In embodiments, the secondary service provider shares revenue from advertising with the ISP, in essence paying the ISP to use its services. A secondary service provider paying an ISP to use its services is a business model and method of doing business that has yet to be introduced into the market. As an extension, the secondary service provider or, more preferably, the ISP, may share revenue from advertising with the ISP customers (i.e., the users in the figure), in essence paying the user to enroll as a customer of the ISP.

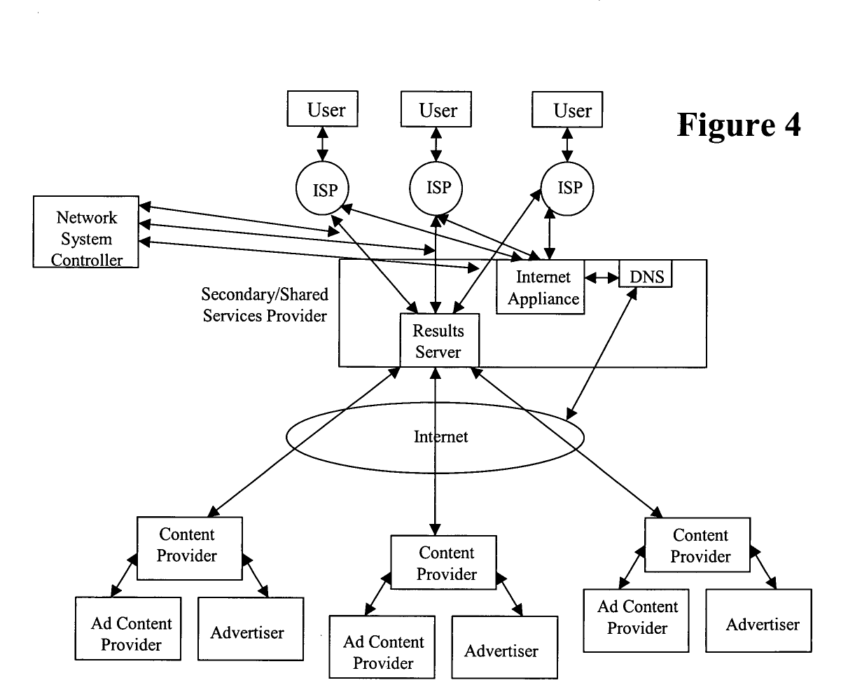

FIG. 4 depicts an embodiment of the invention in which the shared service model is implemented with three ISP sharing the services of a secondary service provider, and where the secondary service provider provides, in addition to DNS functions and redirection functions, network system controller functions. The network system controller functions are any of those discussed above or immediately apparent to those of skill in the art. They include, but are not limited to, account monitoring to determine user usage, advertising content displayed or accessed, purchases from advertisers made by users; number of users opting in and out of redirection services, and any other financial or usage information. The network system controller can provide information to each client ISP and can maintain internal information on each ISP and total usage of the system. The controller can be linked to any number of external systems, such as maintenance and upgrade services, bank or other financial institution services, and back-up or other redundancy services.

For simplicity, the figures indicate only very few service providers (e.g., ISP, secondary service, content). It is to be understood that the systems and methods of the invention are highly scalable, and can include any number of providers to accommodate any number of ultimate users. Multiple copies of each piece of hardware and/or software may be implemented in accordance with standard practices to provide the level of service requested or required by users, ISP, or any other entity involved in the systems. Thus, as one part of the network system controller function, data from systems installed in multiple geographically distinct locations may be collected and, where necessary, synthesized to produce a coherent, complete report or series of reports for one or more ISP enrolled in the systems.

It will be apparent to those skilled in the art that various modifications and variations can be made in the practice of the present invention without departing from the scope or spirit of the invention. Other embodiments of the invention will be apparent to those skilled in the art from consideration of the specification and practice of the invention. It is intended that the specification and examples be considered as exemplary only, with a true scope and spirit of the invention being indicated by the following claims.

1. A computer system for controlling Internet communication traffic, said system comprising:
a DNS server;
an Internet appliance that analyzes a bit strings for the presence of a pre-defined bit string;
a processor that redirects a user of the system to a landing page that is generated, at least in part, based on the pre-defined bit string; and
a content provider that provides information in response to one or more bit strings provided by the Internet appliance.

2. The system of claim 1, further comprising a web server that analyzes requests received and returns content consisting of any combination of search results, advertisements, or other special content.

3. The system of claim 1, further comprising a user.

4. The system of claim 3, comprising multiple users.

5. The system of claim 2, wherein the user is a human being or a machine executing a program.

6. The system of claim 3, wherein the DNS server is under the control of an ISP from which the user has contracted for Internet service, and the Internet appliance is under the control of a secondary service provider, which is not the ISP.

7. The system of claim 3, wherein the DNS server and the Internet appliance are under the control of a secondary service provider, which is not an ISP from which the user has contracted for Internet service.

8. The system of claim 3, comprising an ISP from which the user contracts for Internet service.

9. The system of claim 1, comprising more than one ISP, wherein one or more ISP uses a DNS and/or Internet appliance under the control of a secondary service provider.

10. The system of claim 9, wherein all DNS and Internet appliances are under the control and ownership of the secondary service provider.

11. A method of generating revenue using a computer, said method comprising:
providing Internet service to a user;
providing communication analysis and redirection services to the user,
wherein the analysis and redirection services result in redirection of a user to a landing page when a pre-defined bit string is encountered during a communication session between the user and one or more other users or sites within the Internet infrastructure;
providing information to the user in response to communications from the user to the Internet infrastructure,
wherein the information comprises information relevant to information submitted by the user to the Internet infrastructure, and wherein the information includes advertising;
generating revenue based on providing the advertising.

12. The method of claim 11, wherein the revenue is obtained by an advertiser, an advertising content provider, a content provider, an entity controlling the communication analysis and redirection services, an ISP, the user, or a combination of two or more of these.

13. The method of claim 11, wherein revenue is generated from fixed monthly fees or per-transaction fees.

14. The method of claim 11, wherein revenue is generated by an advertiser from a user through the viewing of an ad, clicking on an ad or the purchase of a service or good from the advertiser by the user as a result of display of the advertiser's advertisement on the redirection landing page.

15. The method of claim 14, wherein revenue generated by the advertiser is shared with an advertising content provider, a content provider, an entity controlling the communication analysis and redirection services, an ISP, the user, or a combination of two or more of these.

16. The method of claim 14, wherein revenue generated by the advertiser is shared with an ISP from whom the user has contracted for Internet service.

17. The method of claim 14, wherein revenue generated by the advertiser is shared with the user.

18. The method of claim 12, wherein the entity controlling the communication analysis and redirection generates revenue from the advertiser based on advertisements supplied on a redirection page generated by the entity.

19. The method of claim 18, wherein a portion of the revenue generated by the entity is shared with an ISP from whom the user has contracted for Internet service.

20. The method of claim 11, wherein revenue is generated by an advertiser, an advertising content provider, a search result content provider, an ISP, a secondary service provider, and a user.
